(19) United States
(12) Patent Application Publication
(10) Pub. No.: US 2023/0319692 A1
(43) Pub. Date: Oct. 5, 2023

(54) LEARNING A CONNECTIVITY STATE OF AN EXTERNAL NETWORK CONNECTION OF A WI-FI ROUTER

(71) Applicant: Microchip Technology Incorporated, Chandler, AZ (US)

(72) Inventors: Vaibhav Madan, Uttar Pradesh (IN); Himanshu Seth, New Delhi (IN)

(21) Appl. No.: 18/059,790

(22) Filed: Nov. 29, 2022

(30) Foreign Application Priority Data
Mar. 30, 2022 (IN) 202241019003

(51) Int. Cl. H04W 48/16; H04W 48/08

(52) U.S. Cl. CPC H04W 48/16; H04W 48/08

(57) ABSTRACT

One or more examples relate to detecting external network connectivity at a Wi-Fi router. A disclosed Wi-Fi router may include a Wi-Fi controller and a connectivity circuit. The connectivity circuit may learn a connectivity state of an external network connection of the Wi-Fi router. The connectivity circuit may provide connectivity state information to the Wi-Fi controller. The connectivity state information may include information about the learned connectivity state of the external network connection of the Wi-Fi router.

### CROSS-REFERENCE TO RELATED APPLICATION

This application claims the benefit of the priority date of Indian Provisional Patent Application No. 202241019003, filed Mar. 30, 2022, and titled “DETECTING INTERNET CONNECTIVITY AT A WI-FI ROUTER AND RELATED SYSTEMS, METHODS, AND DEVICES,” the contents and disclosure of which are incorporated herein in its entirety by this reference.

### BACKGROUND

There is an ever-expanding variety of devices that connect to an electronic network, such as to a wireless local area network (WLAN) at a residence. Such an electronic network is typically managed by a router, a device that, among other things, routes traffic (data packets) and manages requests by devices to connect to the electronic network. Devices typically connect to a router via wired or unwired connections such as cables and wireless frequencies. Access points are devices that provide wireless connectivity between devices and a router. An access point typically has a wired connection to a router (e.g., an internal connection if a router has a built-in access point, or an Ethernet cable for a stand-alone access point, without limitation) and equipment to communicate wirelessly with other devices. Access points and other devices may utilize a variety of wireless communication protocols, but it is common for access points in residential networks to utilize communication protocols that are complaint with one of the Institute of Electrical and Electronics Engineers (IEEE) 802.11 standards for implementing WLAN computer communication, also referred to as “Wi-Fi networks,” which is short for “wireless fidelity networks.”

### BRIEF DESCRIPTION OF THE DRAWINGS

To easily identify the discussion of any particular element or act, the most significant digit or digits in a reference number refer to the figure number in which that element is first introduced.

FIG. 1 is block diagram depicting an apparatus to test, store or provide Wi-Fi router connectivity information, in accordance with one or more examples.

FIG. 2 is a flow diagram depicting a process for reporting connectivity state information about an external network connection of a Wi-Fi router to a Wi-Fi controller of the Wi-Fi router, in accordance with one or more examples.

FIG. 3 is a flow diagram depicting a process to learn the connectivity state of an external network connection of a Wi-Fi router, in accordance with one or more examples.

FIG. 4 is a flow diagram depicting a process for determining connectivity state information about an external network connection of a Wi-Fi router, in accordance with one or more examples.

FIG. 5 is a flow diagram depicting a process for sending connectivity state information about a Wi-Fi router, in accordance with one or more examples.

FIG. 6 is a block diagram of a Wi-Fi device, in accordance with one or more examples.

FIG. 7 is a flow diagram depicting a process for determining whether to connect to a Wi-Fi router based on a connectivity state of an external network connection of the Wi-Fi router, in accordance with one or more examples.

FIG. 8 is a flow diagram depicting a process for a Wi-Fi device controller or connectivity aware connection logic of the same to learn the connectivity state of an external network connection of a Wi-Fi router, in accordance with one or more examples.

FIG. 9 is a flow diagram depicting a process for determining whether to connect to a Wi-Fi router based on a connectivity state of an external network connection of the Wi-Fi router, in accordance with one or more examples.

FIG. 10 is a swimlane diagram of a process to detect Internet connectivity of a Wi-Fi router before disconnecting from a different Wi-Fi router to connect to the Wi-Fi router, in accordance with one or more examples.

FIG. 11 is a flow diagram depicting a process for determining information about a quality of an external network connection, in accordance with one or more examples.

FIG. 12 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example, or this disclosure, to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are example only and should not be construed as the only way to implement the present disclosure unless specified otherwise herein. Additionally, block definitions and partitioning of logic between various blocks are examples of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented utilizing any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

In this description the term “coupled” and derivatives thereof may be utilized to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be utilized in this description interchangeably with the term “coupled,” and have the same meaning unless expressly indicated otherwise or the context would indicate otherwise to a person having ordinary skill in the art.

Any reference to an element herein utilizing a designation such as “first,” “second,” and so forth does not limit the quantity or order of those elements, unless such limitation is explicitly stated. Rather, these designations may be utilized herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As utilized herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

A router that has an internal access point or is coupled to a stand-alone access point is referred to herein as a “wireless router,” and the access point of a wireless router is referred to herein as a “wireless router access point.” A wireless router configured for Wi-Fi connections is referred to herein as a “Wi-Fi router,” and an access point of a Wi-Fi router is referred to herein as a “Wi-Fi router access point.” Notably, a disclosed Wi-Fi router may have one or multiple (more than one) Wi-Fi router access points, that provide the same or different types of connectivity such as, 2.5-Ghz frequency band, 5-Ghz frequency band, secured, and unsecured, without limitation.

When a Wi-Fi device desires to connect to a Wi-Fi router access point, typically, it will probe Wi-Fi signals and Wi-Fi channels in its vicinity for an IEEE 802.11 wireless local area network (WLAN) service set identifier (SSID) broadcast by the Wi-Fi router access point that defines a Wi-Fi network. When the Wi-Fi device detects an SSID on a Wi-Fi channel, it sends a connection request to the Wi-Fi router utilizing the detected SSID and channel of the Wi-Fi router access point to notify the Wi-Fi router that the Wi-Fi device requests to connect to the Wi-Fi router. When the Wi-Fi router notifies the Wi-Fi device that the Wi-Fi router is ready for the Wi-Fi device to attempt to connect, the Wi-Fi device sends the Wi-Fi router a description of the Wi-Fi device's communication capabilities. If the capabilities are acceptable to the Wi-Fi router, the Wi-Fi router assigns and sends the Wi-Fi device an identifier and notifies the Wi-Fi device that the capabilities are acceptable and that the Wi-Fi device may continue the connection process. The Wi-Fi device and Wi-Fi router then establish a secure communication link.

Among other things, Wi-Fi routers are utilized by connected Wi-Fi devices to communicate with each other, and to communicate via connections with networks connected to the Wi-Fi router and networks connected therewith (each an “external network”), such as the Internet, without limitation. A Wi-Fi router's connection with an external network (“an external network connection”) such as the Internet (and more specifically to one or more Internet Service Providers (ISPs)), without limitation, enables the Wi-Fi router and Wi-Fi devices connected to the Wi-Fi router to communicate with external networks and devices connected thereto. The absence of a suitable connection (e.g., no connection or a weak/unreliable connection (e.g., that exhibits too many dropped packets), without limitation) with the external network may be unacceptable for a Wi-Fi device, as a non-limiting example, because it utilizes connections with external networks, and devices and services of external networks.

Sometimes multiple Wi-Fi routers are in the vicinity of a Wi-Fi device, and respective ones of the Wi-Fi routers have their own Internet connections. The respective Internet connections may exhibit different connection qualities at a given moment, for example, one may exhibit Internet connectivity while another may exhibit no Internet connectivity.

If a Wi-Fi router loses Internet connectivity, in response some connected Wi-Fi devices automatically (i.e., without user supervision or confirmation) disconnect from the first Wi-Fi router and connect to a second, different, Wi-Fi router, if available. In some cases, it may be desirable for the Wi-Fi device to connect and utilize the Internet connection of the first Wi-Fi router when the first Wi-Fi router regains Internet connectivity, as a non-limiting example, because the Internet connection of the first Wi-Fi router is faster (e.g., higher throughput, without limitation), the first Wi-Fi router has a stronger signal than the second Wi-Fi router, or the second Wi-Fi router is metered while the first Wi-Fi router is not metered or has less restrictive metering than the second Wi-Fi router, without limitation.

If the Wi-Fi device re-connects to the first Wi-Fi router and the first Wi-Fi router does not have Internet connectivity, re-connecting to the first Wi-Fi router is a waste of time and may reduce user experience.

One or more examples relate, generally, to detecting external network connectivity (e.g., Internet connectivity, without limitation) at a Wi-Fi router. In one or more examples, if a Wi-Fi device detecting external network connectivity is connected to a different Wi-Fi router than the DUT (the “Device Under Test,” which refers to a Wi-Fi router having its external network connectivity tested), the Wi-Fi device may stay connected to the different Wi-Fi router while the Wi-Fi device attempts to detect the external network connectivity of the DUT. If the Wi-Fi device does not detect external network connectivity at the DUT, the Wi-Fi device does not incur an opportunity cost in terms of lost external network connectivity because it maintains the connection to the different Wi-Fi router.

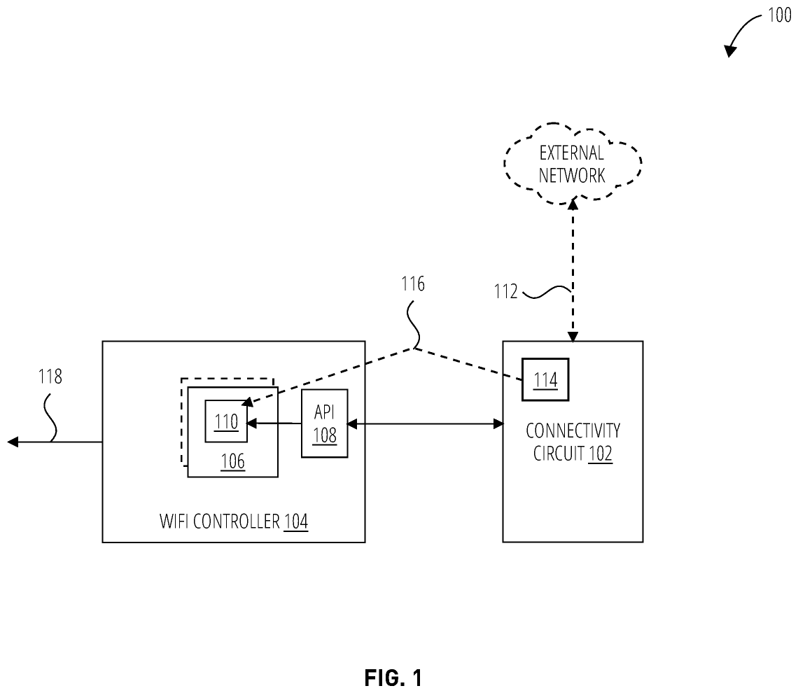

FIG. 1 is block diagram depicting an apparatus 100 to test, store or provide Wi-Fi router connectivity information, in accordance with one or more examples. Apparatus 100 may be, or be a portion of, a Wi-Fi router and is also referred to herein as “Wi-Fi router 100.”

Wi-Fi router 100 includes a Wi-Fi controller 104 and a connectivity circuit 102. An optional external network connection and external network are depicted by FIG. 1 for ease of discussion, but their depiction does not limit the scope of this disclosure in any way.

Wi-Fi controller 104 may perform access point and network configuration, provisioning, and management for Wi-Fi router 100. Wi-Fi controller 104 includes one or more registers 106 to store connectivity state information 110 (also referred to herein as “stored connectivity state information 110”) about Wi-Fi router 100. Wi-Fi controller 104 includes an application programming interface (API) 108 to enable processes or logic circuits external to Wi-Fi controller 104 (e.g., connectivity circuit 102, discussed below, without limitation) to store connectivity state information about Wi-Fi router 100 at one or more registers 106. In one or more examples, bits of one or more registers 106 may be set to represent values indicative of respective connectivity states (i.e., to represent the stored connectivity state information 110) of external network connections of Wi-Fi router 100 such as external network connection 112, without limitation.

Wi-Fi controller 104 may operate in a number of states, including without limitation, states in which Wi-Fi controller 104 may generate packets that provide information about Wi-Fi controller 104 or, more generally, Wi-Fi router 100, such as packets for beacons and probe-responses, without limitation. In one or more examples, a beacon is a management message periodically sent (broadcast) by a Wi-Fi router, such as Wi-Fi router 100. In one or more examples, a probe-response is a message transmitted by a Wi-Fi router, such as Wi-Fi router 100, in response to a probe sent by a Wi-Fi device. In one or more examples, Wi-Fi controller 104 may generate such packet for beacons or probe-responses with an “added field,” and the bits of the added field may be utilized to send connectivity state information 110, such as information about a connectivity state of Wi-Fi router 100, and more specifically, a connectivity state of an external network connection of Wi-Fi router 100 (i.e., about a connectivity state exhibited by Wi-Fi router 100 or an external network connection of Wi-Fi router 100). In one or more examples, the added field may be a field for side-band data, such as a vendor specific information elements (VSIE). An added field may be a typically unused field specified in a Wi-Fi protocol, an optional field specified in a Wi-Fi protocol, or a field added by Wi-Fi controller 104 that is not specified in a Wi-Fi protocol, optional or otherwise, without limitation. In one or more examples, connectivity state information 110 may include information about a learned connectivity state 114 of external network connection 112 as discussed below.

In one or more examples, Wi-Fi controller 104 may enable or disable bits (e.g., set to a binary ‘1’ or ‘0’ to respectively indicate an enabled or a disabled state based on a predetermined convention, without limitation) in added fields of respective packets of beacons or probe-responses to include connectivity state information 110, at least partially based on connectivity state information 110 stored at one or more registers 106 of Wi-Fi controller 104. In this manner, Wi-Fi controller 104, and more generally Wi-Fi router 100, may send connectivity state information 110 about Wi-Fi router 100 to Wi-Fi devices within the vicinity of Wi-Fi router 100. In one or more examples, sent connectivity state information 118 may include, or be at least partially based on, some or a totality of the stored connectivity state information 110.

Sent connectivity state information 118 represented by bits of an added field may include, but are not limited to: indication of no connection with an external network (e.g., indicative of no connection with the Internet, without limitation), or indication of a connection to an external network (e.g., indicative of a connection with the Internet, without limitation). In this manner, the bits of the added field of a packet sent by Wi-Fi controller 104 may be utilized as an indication of a connectivity state of an external network connection of Wi-Fi router 100, including without limitation, active external network connection or inactive external network connection. A Wi-Fi device that receives such a packet, may detect (e.g., infer, without limitation) a connectivity state of an external network connection of Wi-Fi router 100 at least partially based on sent connectivity state information 118 represented by bits of respective added fields of a packet sent by the Wi-Fi router 100.

In one or more examples, connectivity state information 110 and sent connectivity state information 118 may include information about a quality of an external network connection of Wi-Fi router 100. Non-limiting examples of quality of external network connection include: relative strength of a connection (e.g., weak, strong, or a metric for rating relative strength such as according to the relative signal strength index (RSSI), without limitation), bandwidth of a connection, average data volume on the connection, average upload speed of the connection, or average download speed of the connection, without limitation. As a non-limiting example, in some cases Wi-Fi router 100 may utilize a broadband cellular network connection as a backhaul external network connection, and include information about the quality of the broadband cellular network connection with connectivity state information 110 or sent connectivity state information 118.

Wi-Fi router 100 may include one or more connectivity circuits 102 to track external network connectivity and learn connectivity states exhibited by respective external network connections. A respective connectivity circuit 102 may test external network connectivity of Wi-Fi router 100, as a non-limiting example, to connectivity with an external network via external network connection 112 (e.g., provided by a modem, without limitation). Connectivity circuit 102 may include one or more programs for testing existence of a destination (e.g., destination address or destination device, without limitation) in an external network, and may infer a state of external network connectivity in response to whether or not the program detects existence of the destination. As a non-limiting example, such programs for testing existence of a destination in an external network may send a message to the destination, where the message requests/requires a response from the destination. Receipt of the requested/required response may be indicative of existence of the destination.

As a non-limiting example, connectivity circuit 102 may include a Packet Internet or Inter-Network Groper (“PING”) program for testing existence of destination Internet Protocol (IP) addresses by sending a message to a destination address (such a message also called a “ping” and such a test also called “pinging” the destination IP address). Utilizing the PING program, connectivity circuit 102 may ping a known IP address on the Internet, such as a domain name on the World Wide Web, without limitation. In one or more examples, if a response to pinging the destination IP address is not received or not received within a threshold period of time, connectivity circuit 102 may determine the learned connectivity state 114 for an Internet connection is “inactive,” and if the a response to the pinging the destination IP address is received or received within a threshold period of time, the connectivity circuit 102 may determine the learned connectivity state 114 for an Internet connection is “active.”

In one or more examples, connectivity circuit 102 may learn about a quality of an external network connection of Wi-Fi router 100. As a non-limiting example, connectivity circuit 102 may include a program to communicate with a third-party service that reports on the quality of external network connections utilized to communicate with the service, including without limitation, external network connection 112. Connectivity circuit 102 may utilize reporting from such a service to generate one or more quality indicators about external network connection 112 and provide the quality indicators about external network connection 112 with connectivity state information 116, in addition, or as an alternative, to information about learned connectivity state 114.

Connectivity circuit 102 may provide connectivity state information 118 (which may also be referred to herein as “learned connectivity state information 118”), via API 108 provided by Wi-Fi controller 104, to include with stored connectivity state information 110 at one or more registers 106 of Wi-Fi controller 104. Learned connectivity state information 118 stored with stored connectivity state information 110 may include, without limitation, information about a connectivity state of Wi-Fi router 100 for an external network connection 112 or quality indicators about the external network connection 112. Connectivity circuit 102 may store learned connectivity state information 118 at register 106 in response to testing external network connectivity of Wi-Fi router 100. As a non-limiting example, connectivity circuit 102 may store learned connectivity state information 118 at one or more registers 106 that includes information about a connectivity state inferred at least partially in response to test of external network connectivity by connectivity circuit 102 as discussed above. In this manner, connectivity circuit 102 may notify Wi-Fi controller 104 about a connectivity state of Wi-Fi router 100 or external network connection 112 of Wi-Fi router 100 via API 108 and the learned connectivity state information 118 is stored at one or more registers 106 as stored connectivity state information 110.

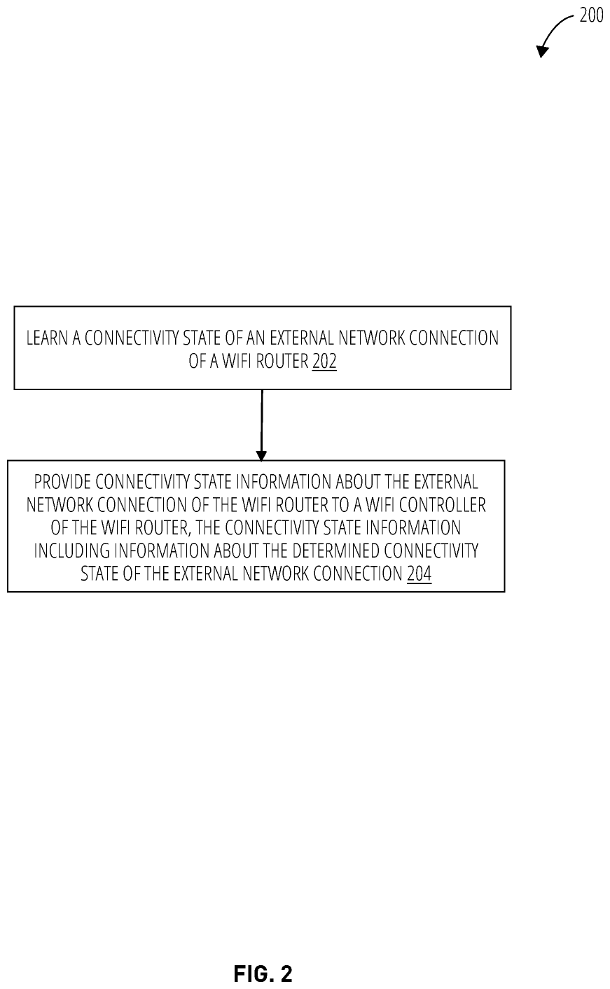

FIG. 2 is a flow diagram depicting a process 200 for reporting connectivity state information about an external network connection of a Wi-Fi router to a Wi-Fi controller of the Wi-Fi router, in accordance with one or more examples. Process 200 may be performed, as a non-limiting example, by connectivity circuit 102 of FIG. 1.

At operation 202, process 200 learns a connectivity state of an external network connection (e.g., external network connection 112, without limitation) of a Wi-Fi router (e.g., Wi-Fi router 100, without limitation).

At operation 204, process 200 provides connectivity state information (e.g., learned connectivity state information 118, without limitation) about the external network connection of the Wi-Fi router to a Wi-Fi controller (e.g., Wi-Fi controller 104, without limitation) of the Wi-Fi router. The connectivity state information includes information about the learned connectivity state (e.g., information about learned connectivity state 114, without limitation) of the external network connection.

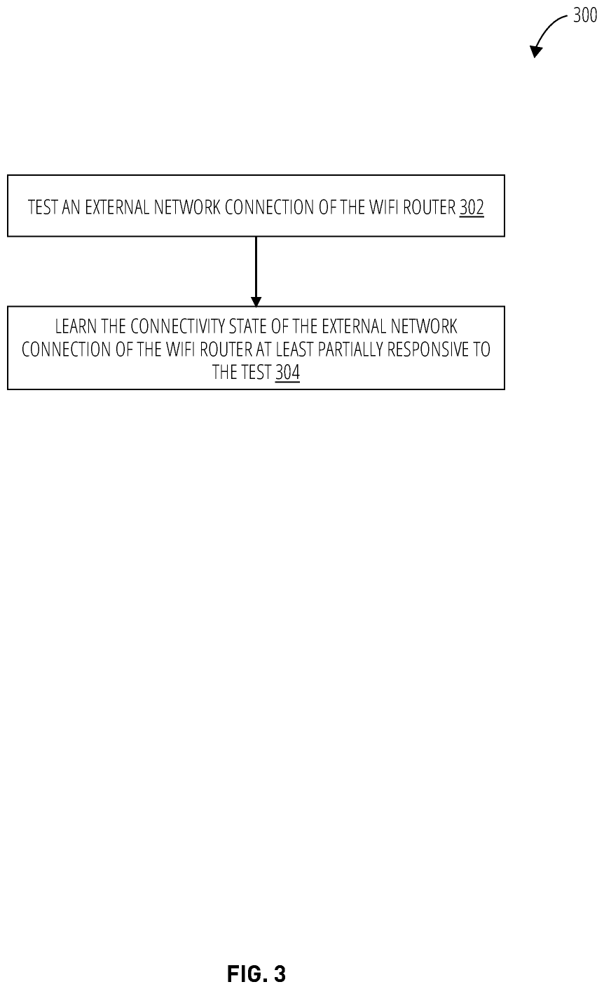

FIG. 3 is a flow diagram depicting a process 300 to learn the connectivity state of an external network connection of a Wi-Fi router, in accordance with one or more examples. As a non-limiting example, process 300 may be performed by a connectivity circuit 102 of a Wi-Fi router, without limitation.

In operation 302, process 300 tests a connectivity state of an external network connection of a Wi-Fi router.

In operation 304, process 300 learns the connectivity state (e.g., the learned connectivity state 114, without limitation) of the external network connection of the Wi-Fi router at least partially responsive to the test of operation 302.

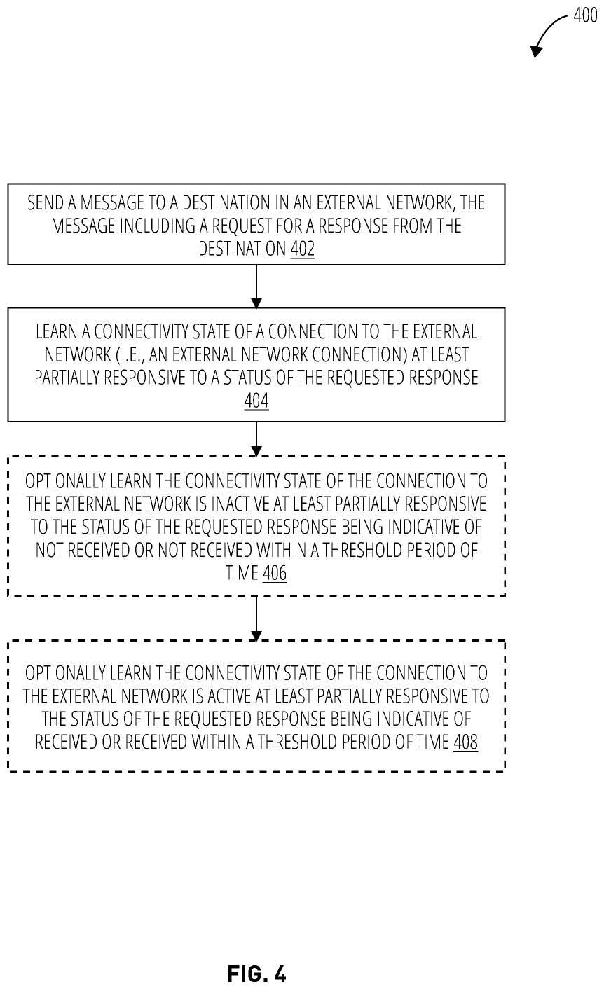

FIG. 4 is a flow diagram depicting a process 400 for learning connectivity state information about an external network connection of a Wi-Fi router, in accordance with one or more examples. Process 400 may be performed, as a non-limiting example, by connectivity circuit 102 of FIG. 1.

At operation 402, process 400 sends a message to a destination (e.g., a destination address, without limitation) in an external network. The message includes a request for a response from the destination.

At operation 404, process 400 learns a connectivity state of a connection to the external network (i.e., an external network connection such as external network connection 112, without limitation) at least partially responsive to a status of the requested response.

At optional operation 406, process 400 optionally determine that the connectivity state for the external network connection is “inactive” in response to the response status being “unreceived” (i.e., a response to the message has not been received or not received within a threshold period of time).

At optional operation 408, process 400 optionally determines that the connectivity state for the external network connection is “active” in response to the response status being “received” (i.e., a response to the messages has been received or received within a threshold period of time).

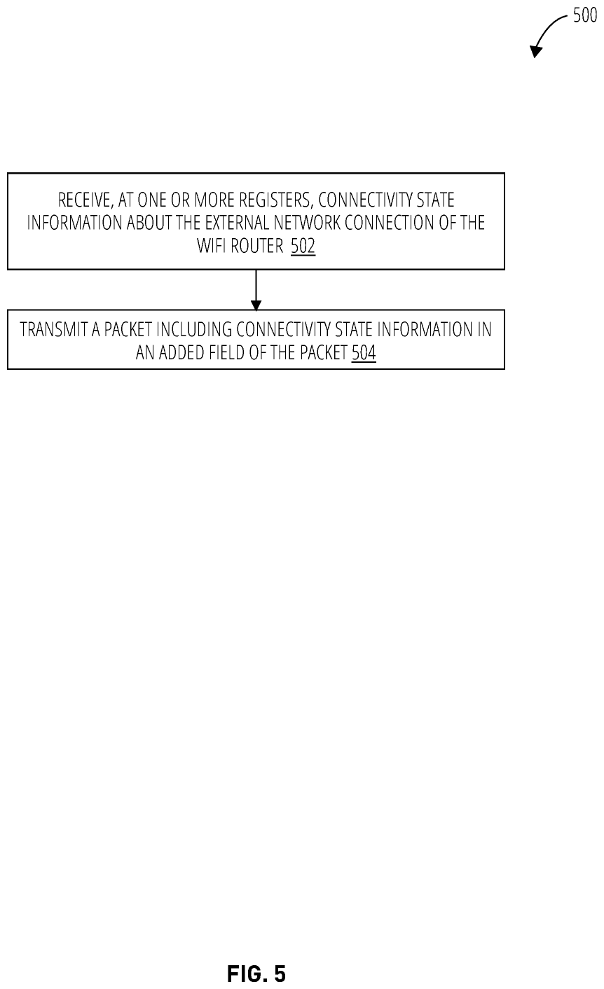

FIG. 5 is a flow diagram depicting a process 500 for sending connectivity state information about a Wi-Fi router, in accordance with one or more examples. As a non-limiting example, process 500 may be performed by Wi-Fi controller of a Wi-Fi router such as Wi-Fi controller 104 of Wi-Fi router 100, without limitation.

In operation 502, process 500 receives (e.g., via API 108, without limitation), at one or more registers (e.g., one or more registers 106, without limitation), connectivity state information (e.g., learned connectivity state information 116, without limitation) about the external network connection (e.g., external network connection 112, without limitation) of a Wi-Fi router (e.g., Wi-Fi router 100, without limitation). The learned connectivity state information received via the API may be stored as stored connectivity state information 110 at the one or more registers 106.

In operation 504, transmits a packet including connectivity state information (e.g., sent connectivity state information 118, without limitation) in an added field of the packet. As discussed above, the packet may be a beacon, probe-response, or other management packet, without limitation.

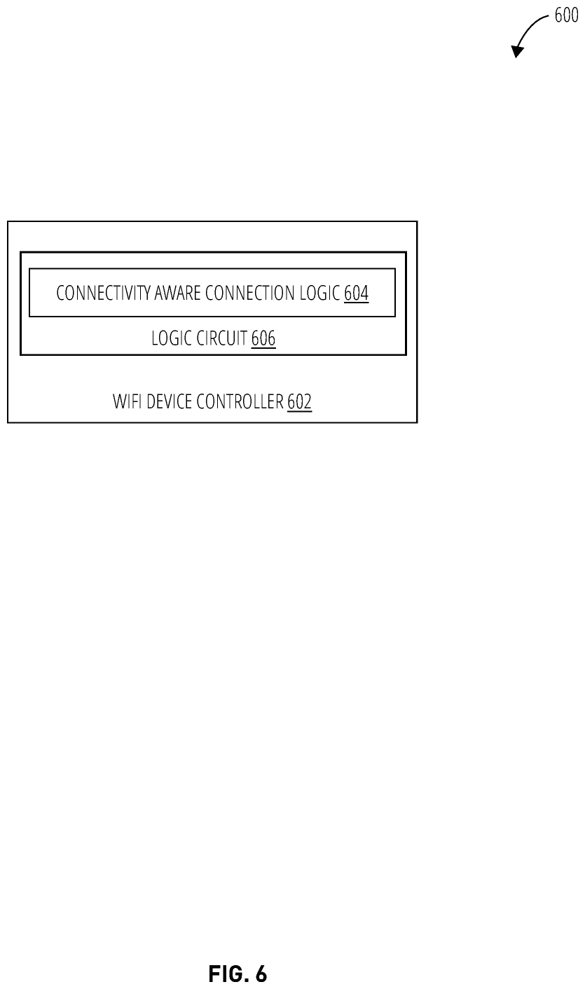

FIG. 6 is a block diagram of an apparatus 600, in accordance with one or more examples. Apparatus 600 includes Wi-Fi device controller 602 for a Wi-Fi device, and so apparatus 600 may also be referred to herein as a Wi-Fi device 600. Wi-Fi device controller 602 of Wi-Fi device 600 includes logic circuit 606 which includes connectivity aware connection logic 604. Connectivity aware connection logic 604 is a connection logic of Wi-Fi device controller 602 for provisioning and managing Wi-Fi connections with a Wi-Fi router, which logic is aware, or attempts to be aware, of a connectivity state of the Wi-Fi router before establishing a connection with the Wi-Fi router and joining a Wi-Fi network managed by the Wi-Fi router.

In one or more examples, connectivity aware connection logic 604 detects external network connectivity of a Wi-Fi router before connecting to the Wi-Fi router or switching connections from a first Wi-Fi router to a second Wi-Fi router. If suitable external network connectivity at the DUT (the “Device Under Test,” which refers to the Wi-Fi router having its external network connectivity investigated) is detected by connectivity aware connection logic 604, then the connectivity aware connection logic 604 permits connection to the DUT. If suitable external network connectivity is not detected by connectivity aware connection logic 604, then the connectivity aware connection logic 604 prohibits connection to the DUT, and Wi-Fi device 600 stays connected to the first Wi-Fi router. Notably, Wi-Fi device 600 may stay connected to a first Wi-Fi router while determining the external network connectivity of a second, unconnected, Wi-Fi router, thus if suitable external network connectivity is not detected by connectivity aware connection logic 604 a connection to the external network via the first Wi-Fi router is not lost or disrupted.

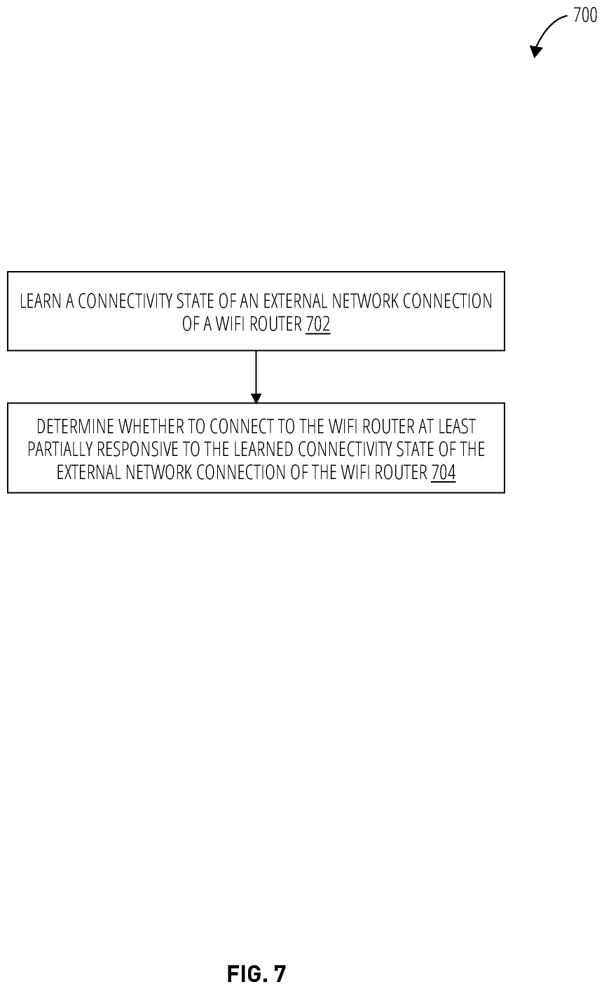

FIG. 7 is a flow diagram depicting a process 700 for determining whether to connect to a Wi-Fi router based on a connectivity state of an external network connection of the Wi-Fi router, in accordance with one or more examples.

In operation 702, process 700 learns a connectivity state of an external network connection of a Wi-Fi router. The Wi-Fi router is an unconnected Wi-Fi router, i.e., it is not connected to a Wi-Fi device performing process 700.

In operation 704, process 700 determines whether, or not, to connect to the Wi-Fi router at least partially responsive to the learned connectivity state of the external network connection of the Wi-Fi router, i.e., to a response received to the query of operation 702.

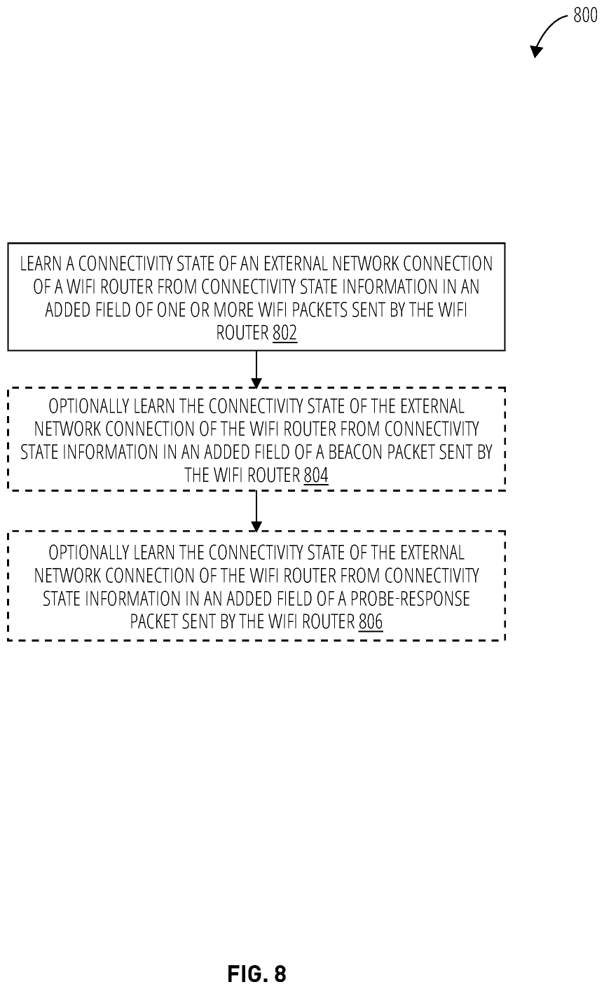

FIG. 8 is a flow diagram depicting a process 800 for a Wi-Fi device controller or connectivity aware connection logic of the same to learn the connectivity state of an external network connection of a Wi-Fi router, in accordance with one or more examples.

In operation 802, process 800 learns a connectivity state of an external network connection of a Wi-Fi router from connectivity state information in an added field of one or more Wi-Fi packets sent by the Wi-Fi router.

In optional operation 804, process 800 optionally learns the connectivity state of the external network connection of the Wi-Fi router from connectivity state information in an added field of a beacon packet sent by the Wi-Fi router.

In optional operation 806, process 800 optionally learns the connectivity state of the external network connection of the Wi-Fi router from connectivity state information (e.g., sent connectivity state information 118, without limitation) in an added field of a probe-response packet sent by the Wi-Fi router.

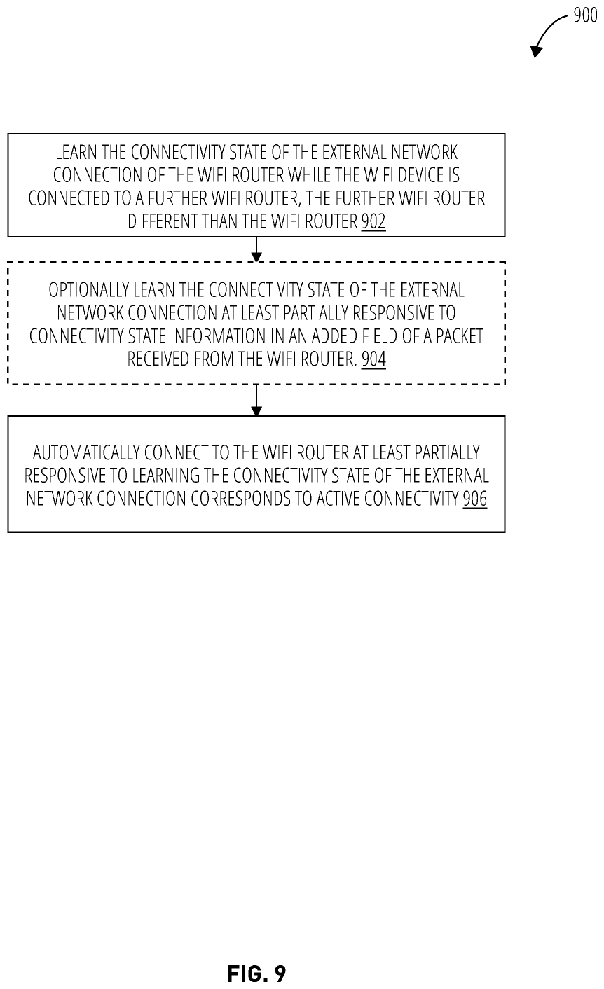

FIG. 9 is a flow diagram depicting a process 900 for determining whether to connect to a Wi-Fi router based on a connectivity state of an external network connection of the Wi-Fi router, in accordance with one or more examples. As a non-limiting example, some or a totality of operations of process 900 may be performed by Wi-Fi device 600, Wi-Fi device controller 602, or connectivity aware connection logic 604.

In operation 902, process 900 learns the connectivity state of the external network connection of the Wi-Fi router while the Wi-Fi device is connected to a further Wi-Fi router, the further Wi-Fi router different than the Wi-Fi router.

In optional operation 904, process 900 learns the connectivity state of the external network connection at least partially responsive to connectivity state information in an added field of a packet received from the Wi-Fi router.

In operation 906, process 900 automatically connects to the Wi-Fi router at least partially responsive to learning the connectivity state of the external network connection corresponds to active connectivity.

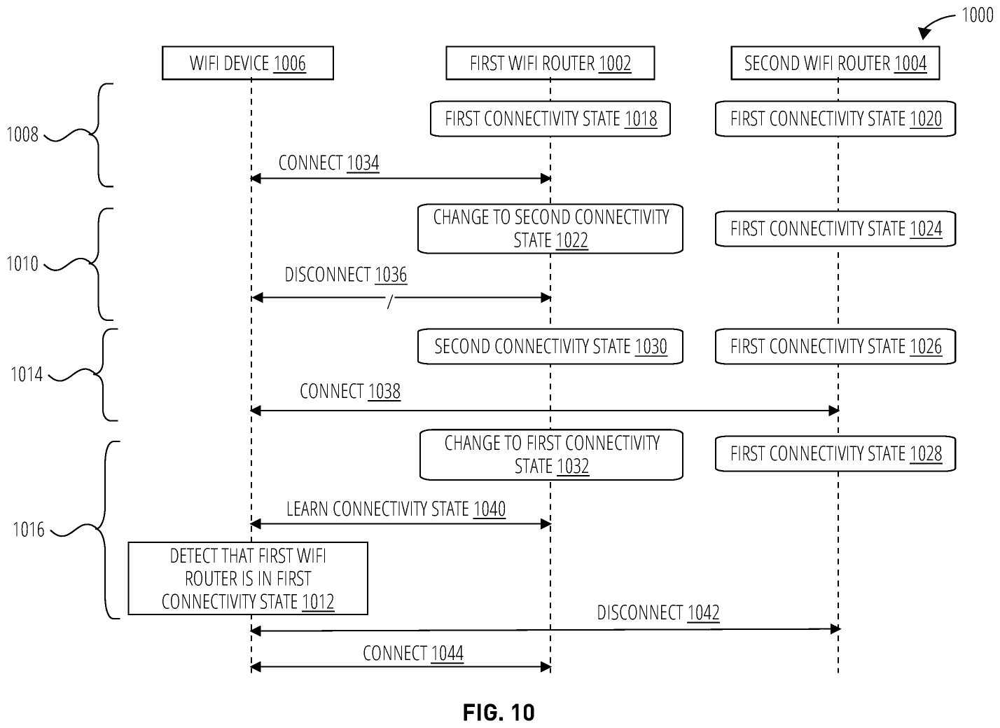

FIG. 10 is a swimlane diagram of a process 1000 to detect Internet connectivity of a Wi-Fi router before disconnecting from a different Wi-Fi router to connect to the Wi-Fi router, in accordance with one or more examples.

FIG. 10 depicts Wi-Fi device 1006, first Wi-Fi router 1002, and second Wi-Fi router 1004 during four phases: phase 1008, phase 1010, phase 1014, and phase 1016. The number and partitioning of the phases depicted by FIG. 10 is merely for convenience of discussion and does not limit this disclosure in any way. First Wi-Fi router 1002 and second Wi-Fi router 1004 are respective non-limiting examples of Wi-Fi router 100.

During phase 1008, first Wi-Fi router 1002 exhibits a respective first connectivity state during operation 1018, and second Wi-Fi router 1004 exhibits a respective first connectivity state during operation 1020. At operation 1034, Wi-Fi device 1006 connects to first Wi-Fi router 1002. In the example contemplated by FIG. 10, the first connectivity state represents Internet connectivity (e.g., active Internet connection, without limitation) and a second connectivity state represents no Internet connectivity (e.g., inactive Internet connection).

During phase 1010, first Wi-Fi router 1002 exhibits a change to second connectivity state at operation 1022, while second Wi-Fi router 1004 exhibits first connectivity state at operation 1024. The change to second connectivity state operation 1022 by first Wi-Fi router 1002 may be in response to, as non-limiting examples: a reboot or power down of first Wi-Fi router 1002, reboot or power down of a modem providing an Internet connection to first Wi-Fi router 1002, or disruption of a physical connection that is necessary for Internet connectivity (e.g., disconnecting an Ethernet cable or Coaxial cable, without limitation). At operation 1036, Wi-Fi device 1006 disconnects from first Wi-Fi router 1002, for example, in response to the change to the second connectivity state in operation 1022 or events giving rise to the same.

During phase 1014, first Wi-Fi router 1002 exhibits second connectivity state at operation 1030, and second Wi-Fi router 1004 exhibits first connectivity state at operation 1026. At operation 1038, Wi-Fi device 1006 connects to second Wi-Fi router 1004. In one or more examples, Wi-Fi device 1006 connects to second Wi-Fi router 1004, automatically, in response to first Wi-Fi router 1002 changing to the second connectivity state in operation 1022 and in response (as discussed herein) to second Wi-Fi router 1004 exhibiting first connectivity state at operation 1026.

During phase 1016, at operation 1040, Wi-Fi device 1006 learns the connectivity state exhibited by first Wi-Fi router 1002 (i.e., the connectivity state of Internet connectivity of first Wi-Fi router 1002) as a non-limiting example, by sending a probe to incite a response sent by first Wi-Fi router 1002 that includes the added field or by reading beacons including the added field sent by first Wi-Fi router 1002. In the specific example depicted by FIG. 10, second Wi-Fi router 1004 exhibits first connectivity state at operation 1028. In the specific example depicted by FIG. 10, first Wi-Fi router 1002 changes to first connectivity state at operation 1032, so when Wi-Fi device 1006 learns connectivity state information (i.e., reads the bits of the added field used to represent the connectivity state of first Wi-Fi router 1002) at operation 1040, the bits indicate first connectivity state. Prior to the change to first connectivity state, the bits of the added field would have indicated second connectivity state or “no Internet connectivity.”

In response to detecting at operation 1012 the connectivity state of first Wi-Fi router 1002 is the first connectivity state, Wi-Fi device 1006 disconnects from second Wi-Fi router 1004 at operation 1042 and connects to first Wi-Fi router 1002 at operation 1044. In one or more examples, Wi-Fi device 1006 may, at operation 1042, automatically (i.e., without user supervision or confirmation) disconnect from second Wi-Fi router 1004 and, at operation 1044, connect to first Wi-Fi router 1002 in response to detecting that first Wi-Fi router 1002 has first connectivity state at operation 1012.

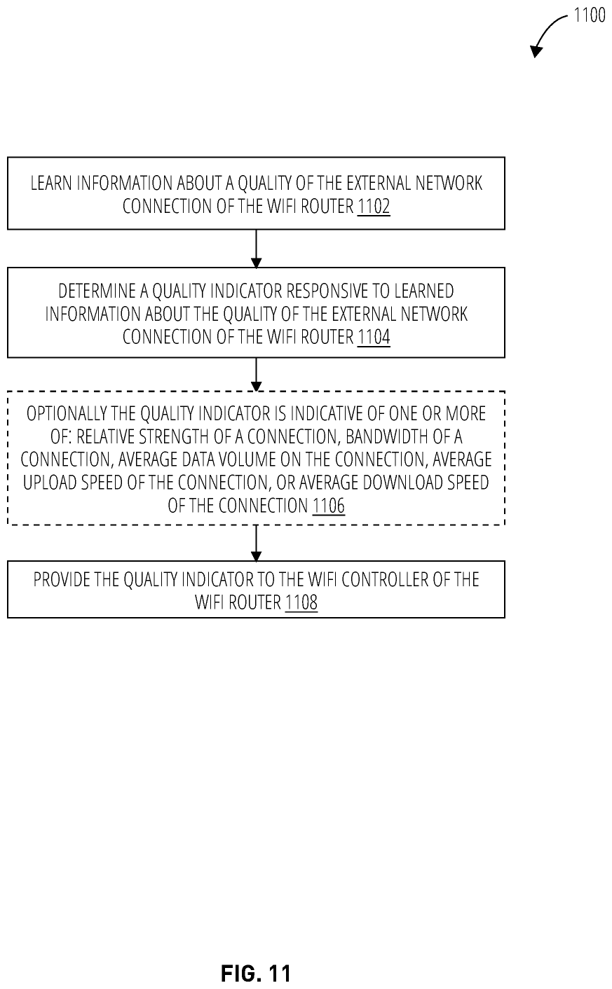

FIG. 11 is a flow diagram depicting a process 1100 for learning information about a quality of an external network connection, in accordance with one or more examples. Process 1100 may be performed, as a non-limiting example by connectivity circuit 102.

At operation 1102, process 1100 learns information about a quality of the external network connection of the Wi-Fi router. As discussed above, non-limiting examples of the quality of external network connection include: relative strength of a connection, bandwidth of a connection, average data volume on the connection, average upload speed of the connection, or average download speed of the connection, without limitation. As a non-limiting example, process 1100 may communicate with a third-party service via an external network connection that reports on the quality of external network connections utilized to communicate with the service.

At operation 1104, process 1100 determines a quality indicator responsive to learned information about the quality of the external network connection of the Wi-Fi router. A quality indicator may include, without limitation, information about, or indicative of, the quality of the external network connection learned in operation 1102.

At operation 1106, optionally the quality indicator is indicative of one or more of: relative strength of a connection, bandwidth of a connection, average data volume on the connection, average upload speed of the connection, or average download speed of the connection.

At operation 1108, process 1100 provides the quality indicator to the Wi-Fi controller of the Wi-Fi router. In one or more examples, process 1100 may store, via an API provided by the Wi-Fi controller, connectivity state information 110 that includes the quality indicators at one or more registers of the Wi-Fi controller (e.g., store, via API 108, learned connectivity state information 116 that includes quality indicators at one or more registers 106 of Wi-Fi controller 104 of Wi-Fi router 100, without limitation).

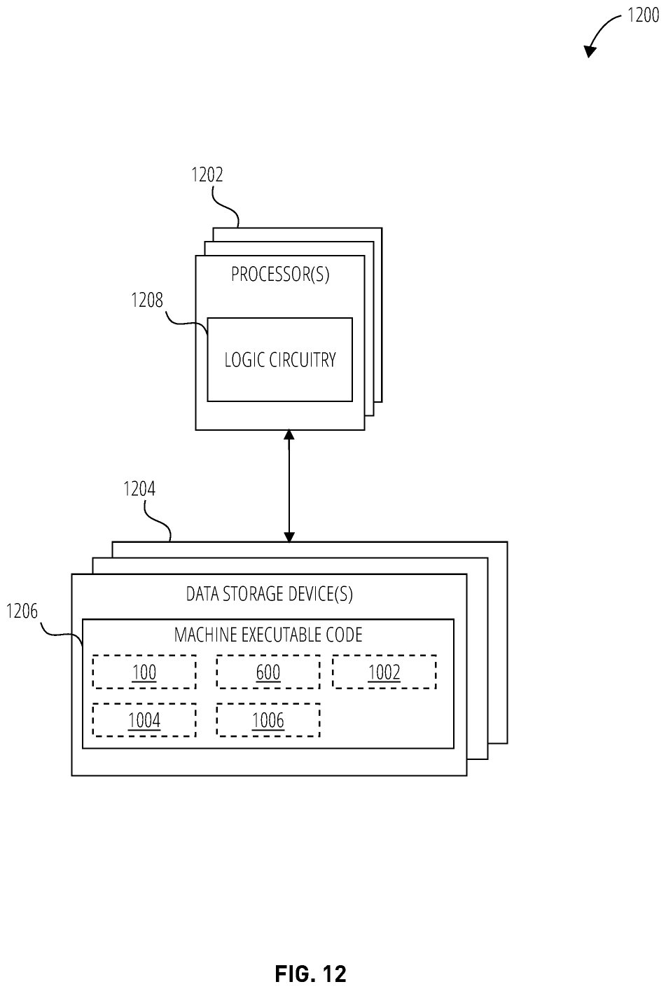

It will be appreciated by those of ordinary skill in the art that functional elements of examples disclosed herein (e.g., functions, operations, acts, processes, or methods) may be implemented in any suitable hardware, software, firmware, or combinations thereof. FIG. 12 illustrates non-limiting examples of implementations of functional elements disclosed herein. In some examples, some or all portions of the functional elements disclosed herein may be performed by hardware specially configured for carrying out the functional elements.

It will be appreciated by those of ordinary skill in the art that functional elements of examples disclosed herein (e.g., functions, operations, acts, processes, or methods) may be implemented in any suitable hardware, software, firmware, or combinations thereof. FIG. 12 illustrates non-limiting examples of implementations of functional elements disclosed herein. In some examples, some or all portions of the functional elements disclosed herein may be performed by hardware specially configured for carrying out the functional elements.

FIG. 12 is a block diagram of a circuitry 1200 that, in some examples, may be used to implement various functions, operations, acts, processes, or methods disclosed herein. The circuitry 1200 includes one or more processors 1202 (sometimes referred to herein as “processors 1202”) operably coupled to one or more data storage devices 1204 (sometimes referred to herein as “storage 1204”). The storage 1204 includes machine executable code 1206 stored thereon and the processors 1202 include logic circuitry 1208. The machine executable code 1206 information describing functional elements that may be implemented by (e.g., performed by) the logic circuitry 1208. The logic circuitry 1208 may implement (e.g., perform) the functional elements described by the machine executable code 1206. The circuitry 1200, when executing the functional elements described by the machine executable code 1206, should be considered as special purpose hardware for carrying out functional elements disclosed herein. In some examples the processors 1202 may perform the functional elements described by the machine executable code 1206 sequentially, concurrently (e.g., on one or more different hardware platforms), or in one or more parallel process streams.

When implemented by logic circuitry 1208 of the processors 1202, the machine executable code 1206 adapt the processors 1202 to perform operations of examples disclosed herein. By way of non-limiting example, the machine executable code 1206 may adapt the processors 1202 to perform some or a totality of operations of one or more of: process 200, process 300, process 400, process 500, process 700, process 800, process 900, process 1000, or process 1100.

Also by way of non-limiting example, the machine executable code 1206 may adapt the processors 1202 to perform some or a totality of features, functions, or operations disclosed herein for one or more of: Wi-Fi router 100 or Wi-Fi device 600. More specifically, features, functions, or operations disclosed herein for one or more of: connectivity circuit 102, Wi-Fi controller 104, one or more registers 106, API 108, Wi-Fi device controller 602, connectivity aware connection logic 604, first Wi-Fi router 1002, second Wi-Fi router 1004, or Wi-Fi device 1006.

The processors 1202 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer may execute functional elements corresponding to the machine executable code 1206 (e.g., software code, firmware code, hardware descriptions) related to examples of the present disclosure. It is noted that a general-purpose processor (may also be referred to herein as a host processor or simply a host) may be a microprocessor, but in the alternative, the processors 1202 may include any conventional processor, controller, microcontroller, or state machine. The processors 1202 may also be implemented as a combination of computing devices, such as a combination of a DSP and a microprocessor, a plurality of microprocessors, one or more microprocessors in conjunction with a DSP core, or any other such configuration.

In some examples the storage 1204 includes volatile data storage (e.g., random-access memory (RAM)), non-volatile data storage (e.g., Flash memory, a hard disc drive, a solid state drive, erasable programmable read-only memory (EPROM), without limitation). In some examples the processors 1202 and the storage 1204 may be implemented into a single device (e.g., a semiconductor device product, a system on chip (SOC), without limitation). In some examples the processors 1202 and the storage 1204 may be implemented into separate devices.

In some examples the machine executable code 1206 may include computer-readable instructions (e.g., software code, firmware code). By way of non-limiting example, the computer-readable instructions may be stored by the storage 1204, accessed directly by the processors 1202, and executed by the processors 1202 using at least the logic circuitry 1208. Also by way of non-limiting example, the computer-readable instructions may be stored on the storage 1204, transferred to a memory device (not shown) for execution, and executed by the processors 1202 using at least the logic circuitry 1208. Accordingly, in some examples the logic circuitry 1208 includes electrically configurable logic circuitry 1208.

In some examples the machine executable code 1206 may describe hardware (e.g., circuitry) to be implemented in the logic circuitry 1208 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1208 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 1206 may include an HDL, an RTL, a GL description, a mask level description, other hardware description, or any combination thereof.

In examples where the machine executable code 1206 includes a hardware description (at any level of abstraction), a system (not shown, but including the storage 1204) may be configured to implement the hardware description described by the machine executable code 1206. By way of non-limiting example, the processors 1202 may include a programmable logic device (e.g., an FPGA or a PLC) and the logic circuitry 1208 may be electrically controlled to implement circuitry corresponding to the hardware description into the logic circuitry 1208. Also by way of non-limiting example, the logic circuitry 1208 may include hard-wired logic manufactured by a manufacturing system (not shown, but including the storage 1204) according to the hardware description of the machine executable code 1206.

Regardless of whether the machine executable code 1206 includes computer-readable instructions or a hardware description, the logic circuitry 1208 perform the functional elements described by the machine executable code 1206 when implementing the functional elements of the machine executable code 1206. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). As used herein, “each” means some or a totality. As used herein, “each and every” means a totality.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: A Wi-Fi router, comprising: a Wi-Fi controller; and a connectivity circuit to learn a connectivity state of an external network connection of the Wi-Fi router and provide connectivity state information to the Wi-Fi controller, wherein the connectivity state information includes information about the learned connectivity state of the external network connection of the Wi-Fi router.

Example 2: The Wi-Fi router according to Example 1, wherein the connectivity circuit to provide the connectivity state information to the Wi-Fi controller via an Application Programming Interface (API) provided by the Wi-Fi controller.

Example 3: The Wi-Fi router according to any of Examples 1 and 2, wherein to learn the connectivity state of the external network connection, the connectivity circuit to: test the external network connection of the Wi-Fi router; and determine the connectivity state of the external network connection of the Wi-Fi router at least partially responsive to the test.

Example 4: The Wi-Fi router according to any of Examples 1 through 3, wherein to test the external network connection of the Wi-Fi router, the connectivity circuit to: send a message to a destination in an external network, the message including a request for a response from the destination; and determine the connectivity state of the connection to the external network at least partially responsive to a status of the requested response.

Example 5: The Wi-Fi router according to any of Examples 1 through 4, wherein the connectivity circuit to: learn information about a quality of the external network connection of the Wi-Fi router; determine a quality indicator responsive to learned information about the quality of the external network connection of the Wi-Fi router; and provide the quality indicator to the Wi-Fi controller.

Example 6: The Wi-Fi router according to any of Examples 1 through 5, wherein the quality indicator is indicative of one or more of: relative strength of a connection, bandwidth of a connection, average data volume on the connection, average upload speed of the connection, or average download speed of the connection.

Example 7: The Wi-Fi router according to any of Examples 1 through 6, wherein the Wi-Fi controller to generate beacons or probe-responses that include the connectivity state information.

Example 8: The Wi-Fi router according to any of Examples 1 through 7, wherein the Wi-Fi controller includes one or more registers to store the connectivity state information received from the connectivity circuit.

Example 9: A Wi-Fi device, comprising: a Wi-Fi device controller to manage connections to Wi-Fi routers; and a logic circuit of the Wi-Fi device controller, the logic circuit to: learn a connectivity state of an external network connection of a Wi-Fi router; and determine whether to connect to the Wi-Fi router at least partially responsive to the learned connectivity state of the external network connection of the Wi-Fi router.

Example 10: The Wi-Fi device according to Example 9, wherein the logic circuit to learn the connectivity state of the external network connection of the Wi-Fi router while the Wi-Fi device is connected to a further Wi-Fi router, the further Wi-Fi router different than the Wi-Fi router.

Example 11: The Wi-Fi device according to any of Examples 9 and 10, wherein the logic circuit to: automatically connect to the Wi-Fi router at least partially responsive to determining the connectivity state of the external network connection corresponds to active connectivity.

Example 12: The Wi-Fi device according to any of Examples 9 through 11, wherein the logic circuit to: determine the connectivity state of the external network connection at least partially responsive to connectivity state information in an added field of a packet received from the Wi-Fi router.

Example 13: A method, comprising: learning a connectivity state of an external network connection of a Wi-Fi router; and determining whether to connect to the Wi-Fi router at least partially responsive to the learned connectivity state of the external network connection.

Example 14: A method, comprising: learning a connectivity state of an external network connection of a Wi-Fi router; and providing connectivity state information about the external network connection of the Wi-Fi router to a Wi-Fi controller of the Wi-Fi router, the connectivity state information including information about the learned connectivity state of the external network connection.

Example 15: The method according to Example 14, wherein learning the connectivity state of the external network connection of the Wi-Fi router comprises: testing the external network connection of the Wi-Fi router; and determining the connectivity state of the external network connection of the Wi-Fi router at least partially responsive to the test.

Example 16: The method according to any of Examples 14 and 15, wherein the testing the external network connection of the Wi-Fi router comprises: sending a message to a destination in an external network, the message including a request for a response from the destination; and determining a connectivity state of the external network connection at least partially responsive to a status of the requested response.

Example 17: A system, comprising: a first Wi-Fi router to provide a first external network connection; a second Wi-Fi router to provide a second external network connection, wherein respective connections of the first external network connection and second external network connection are to a same external network; and a Wi-Fi device, while connected to the second Wi-Fi router, to: learn a connectivity state of the first external network connection of the first Wi-Fi router; and determine whether to connect to the first Wi-Fi router at least partially responsive to the learned connectivity state of the first external network connection.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventor.

What is claimed is:

1. A Wi-Fi router, comprising:
a Wi-Fi controller; and
a connectivity circuit to learn a connectivity state of an external network connection of the Wi-Fi router and provide connectivity state information to the Wi-Fi controller, wherein the connectivity state information includes information about the learned connectivity state of the external network connection of the Wi-Fi router.

2. The Wi-Fi router of claim 1, wherein the connectivity circuit to provide the connectivity state information to the Wi-Fi controller via an Application Programming Interface (API) provided by the Wi-Fi controller.

3. The Wi-Fi router of claim 1, wherein to learn the connectivity state of the external network connection, the connectivity circuit to:
test the external network connection of the Wi-Fi router; and
determine the connectivity state of the external network connection of the Wi-Fi router at least partially responsive to the test.

4. The Wi-Fi router of claim 3, wherein to test the external network connection of the Wi-Fi router, the connectivity circuit to:
send a message to a destination in an external network, the message including a request for a response from the destination; and
determine the connectivity state of the connection to the external network at least partially responsive to a status of the requested response.

5. The Wi-Fi router of claim 1, wherein the connectivity circuit to:
learn information about a quality of the external network connection of the Wi-Fi router;
determine a quality indicator responsive to learned information about the quality of the external network connection of the Wi-Fi router; and
provide the quality indicator to the Wi-Fi controller.

6. The Wi-Fi router of claim 5, wherein the quality indicator is indicative of one or more of: relative strength of a connection, bandwidth of a connection, average data volume on the connection, average upload speed of the connection, or average download speed of the connection.

7. The Wi-Fi router of claim 1, wherein the Wi-Fi controller to generate beacons or probe-responses that include the connectivity state information.

8. The Wi-Fi router of claim 1, wherein the Wi-Fi controller includes one or more registers to store the connectivity state information received from the connectivity circuit.

9. A Wi-Fi device, comprising:
a Wi-Fi device controller to manage connections to Wi-Fi routers; and
a logic circuit of the Wi-Fi device controller, the logic circuit to:
learn a connectivity state of an external network connection of a Wi-Fi router; and
determine whether to connect to the Wi-Fi router at least partially responsive to the learned connectivity state of the external network connection of the Wi-Fi router.

10. The Wi-Fi device of claim 9, wherein the logic circuit to learn the connectivity state of the external network connection of the Wi-Fi router while the Wi-Fi device is connected to a further Wi-Fi router, the further Wi-Fi router different than the Wi-Fi router.

11. The Wi-Fi device of claim 9, wherein the logic circuit to:
automatically connect to the Wi-Fi router at least partially responsive to determining the connectivity state of the external network connection corresponds to active connectivity.

12. The Wi-Fi device of claim 9, wherein the logic circuit to:
determine the connectivity state of the external network connection at least partially responsive to connectivity state information in an added field of a packet received from the Wi-Fi router.

13. A method, comprising:
learning a connectivity state of an external network connection of a Wi-Fi router; and
determining whether to connect to the Wi-Fi router at least partially responsive to the learned connectivity state of the external network connection.

14. A method, comprising:
learning a connectivity state of an external network connection of a Wi-Fi router; and
providing connectivity state information about the external network connection of the Wi-Fi router to a Wi-Fi controller of the Wi-Fi router, the connectivity state information including information about the learned connectivity state of the external network connection.

15. The method of claim 14, wherein learning the connectivity state of the external network connection of the Wi-Fi router comprises:
testing the external network connection of the Wi-Fi router; and
determining the connectivity state of the external network connection of the Wi-Fi router at least partially responsive to the test.

16. The method of claim 15, wherein the testing the external network connection of the Wi-Fi router comprises:
sending a message to a destination in an external network, the message including a request for a response from the destination; and
determining a connectivity state of the external network connection at least partially responsive to a status of the requested response.

17. A system, comprising:
a first Wi-Fi router to provide a first external network connection;
a second Wi-Fi router to provide a second external network connection,
wherein respective connections of the first external network connection and second external network connection are to a same external network; and
a Wi-Fi device, while connected to the second Wi-Fi router, to:
learn a connectivity state of the first external network connection of the first Wi-Fi router; and
determine whether to connect to the first Wi-Fi router at least partially responsive to the learned connectivity state of the first external network connection.
